(19) United States
(12) Patent Application Publication
(10) Pub. No.: US 2010/0033495 A1
(43) Pub. Date: Feb. 11, 2010

(54) IMAGE PROCESSING APPARATUS AND IMAGE PROCESSING METHOD

(76) Inventors: Kai-Hsiang Hsu, Tucheng City (TW); Yi-Chia Shan, Jhongli City (TW)

Correspondence Address: Muncy, Geissler, Olds & Lowe, PLLC, P.O. BOX 1364, FAIRFAX, VA, 22038-1364, US

(21) Appl. No.: 12/415,680

(22) Filed: Mar. 31, 2009

(30) Foreign Application Priority Data
Aug. 6, 2008 (TW) 097129795

(51) Int. Cl. G09G 5/02; G09G 5/00

(52) U.S. Cl. 345/591; 345/617

(57) ABSTRACT

The invention discloses an image processing apparatus and an image processing method, for adjusting the contrast of an input image. The input image consists of plural pixels and each pixel has a respective input lightness. The apparatus can perform a normalization procedure on the pixels to obtain a respective normalized lightness of each pixel. In addition, the apparatus generates lightness statistics based on the pixels and determines plural threshold lightness based on the lightness statistics. According to the normalized lightness and the threshold lightness, the apparatus can change the lightness gain of a specific region of the input image dynamically, and thereby adjust the contrast of the input image.

### BACKGROUND OF THE INVENTION

1. Field of the Invention

The present invention relates to an image processing apparatus and an image processing method. More particularly, the invention relates to an apparatus and a method for adjusting the contrast of an input image.

2. Description of the Prior Art

In general, the contrast of an image means the lightness ratio between the bright region and the dark-region of the image. The enhancement of the contrast can lighten the brighter region a little and darken the darker region a little. The enhancement of the contrast sometimes may make the image lose a little bit information, but for most people, a suitable increase of the contrast can be favored.

For a display or a television, the increase of the contrast can be achieved by adjusting the Gamma coefficient, which changes the relation between gray level signals and lightness. Alternatively, it can be achieved by adjusting the gain of the lightness component of the image by the chips of the display (e.g. an image decoder or an image converter). However, a common adjustment for contrast is usually not suitable for all kinds of images.

Please refer to FIG. 1. FIG. 1 illustrates a lightness input-output curve generated by the contrast adjustment method in the prior art. The horizontal axis represents the input lightness and the vertical axis represents the output lightness. The solid line represents the lightness input-output curve without any treatment, and the dash line represents the lightness input-output curve after the traditional contrast adjustment. As shown in FIG. 1, after the adjustment, the lightness of the pixels originally having the lightness lower than the 130 gray level will be decreased further, and the lightness of the pixels originally having the lightness bigger than the 130 gray level will be increased further. Thus, the contrast of the image is enhanced.

The realization for the lightness input-output curve after the adjustment can be achieved by the following formula:

Lₒᵤₜ=Lᵢₙ*G;

where Lₒᵤₜ and Lᵢₙ represent the output and input lightness of each pixel in the image, respectively. G is a gain in the range of 0 to 2. Different input lightness Lᵢₙ can correspond to different gains G, that is, G is a function of Lᵢₙ. The relation between the input lightness Lᵢₙ and the gain G can be established in a look-up table. After the contrast-adjusting circuit is implemented, a corresponding gain G can be found in the look-up table according to the input lightness Lᵢₙ, and then the aforementioned formula can be executed to generate the output lightness Lₒᵤₜ.

However, the adjustment in the prior art can only increase the contrast of an image with a wide lightness distribution. If the lightness of certain image merely distributes in the range of 0 to the 130 gray level, after the aforementioned treatment by the formula, the lightness of the whole image will further decrease instead of the contrast being increased. As a result, the regions with low lightness in the image become so dark that their details are lost, which results in a bad adjustment. On the contrary, if the lightness of certain image merely distributes in the range of the 130 to the 255 gray level, after the aforementioned treatment, only the lightness of the whole image will further increase instead of the contrast. Consequently, it is observed that the adjustment way in the prior art is not suitable for all kinds of images.

Therefore, to solve the aforementioned problem, the main scope of the invention is to provide an image processing apparatus and an image processing method.

### SUMMARY OF THE INVENTION

One scope of the invention is to provide an image processing apparatus and an image processing method, for adjusting the contrast of an input image. The input image consists of plural pixels and each pixel has a respective input lightness.

According to an embodiment of the invention, the image processing apparatus contains a first processing module, a second processing module, a gain determining module and a third processing module. The gain determining module is electrically connected to the first processing module and the second processing module. The third processing module is electrically connected to the second processing module and the gain determining module.

The first processing module is used for performing a normalization procedure on the input lightness of plural pixels to obtain a respective normalized lightness of each pixel, and determining, based on the respective normalized lightness and a first gain function, a first gain corresponding to the respective normalized lightness. The second processing module is used for generating, based on the input lightness of the plural pixels, a lightness statistics and determining, based on the lightness statistics, plural threshold lightness. The second processing module also determines, based on the plural threshold lightness and a second gain function, plural second gains corresponding to the plural threshold lightness, respectively. The gain determining module is used for determining, based on the first gain corresponding to the normalized lightness of each pixel, a target second gain, from the second gains, corresponding to the normalized lightness. The third processing module is used for generating, based on the input lightness, the corresponding first gain, and the corresponding target second gain of each pixel, an output lightness corresponding to the input lightness to adjust the contrast of the input image.

It is related to an image processing method according to another embodiment of the invention. An input image consists of plural pixels and each pixel has a respective input lightness.

A normalization procedure is executed on the input lightness of the plural pixels to obtain a respective normalized lightness of each pixel. A lightness statistics is generated based on the input lightness of the plural pixels, and plural threshold lightness can be determined based on the lightness statistics.

Next, based on the respective normalized lightness and a first gain function, a first gain corresponding to the respective normalized lightness can be determined. Based on the plural threshold lightness and a second gain function, plural second gains corresponding to the plural threshold lightness can be determined, respectively.

Then, based on the first gain corresponding to the respective normalized lightness of each pixel, a target second gain corresponding to the respective normalized lightness can be determined from the second gains.

Afterwards, an output lightness corresponding to the input lightness of each pixel can be generated based on the input lightness, the corresponding first gain, and the corresponding target second gain of each pixel. Thereby, the contrast of the input image can be adjusted.

The advantage and spirit of the invention may be understood by the following recitations together with the appended drawings.

### BRIEF DESCRIPTION OF THE APPENDED DRAWINGS

FIG. 1 illustrates a lightness input-output curve generated by the contrast adjustment method in the prior art.

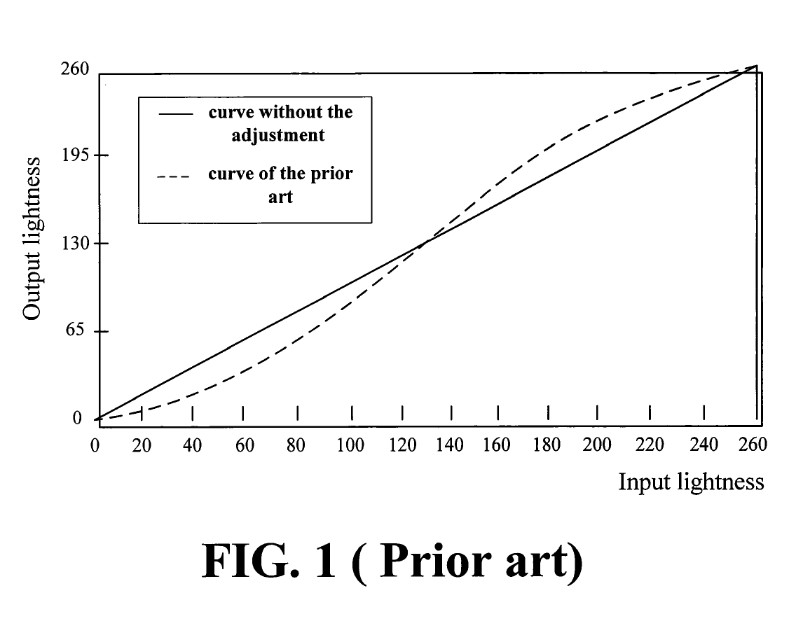

FIGS. 2A and 2B illustrate function block diagrams of the image processing apparatus according to the invention.

FIG. 3A illustrates a schematic diagram of the first look-up table stored in the first storage unit.

FIG. 3B illustrates a schematic diagram of the second look-up table stored in the second storage unit.

FIG. 4 illustrates a lightness statistical graph based on the lightness statistics.

FIGS. 5A and 6A illustrate lightness statistical histograms for two images whose contrasts need to be adjusted, respectively.

FIGS. 5B and 6B illustrate lightness curve simulations for the images adjusted by the image processing apparatus of the invention, respectively.

FIG. 7 illustrates a flow chart of an image processing method according to another embodiment of the invention.

### DETAILED DESCRIPTION OF THE INVENTION

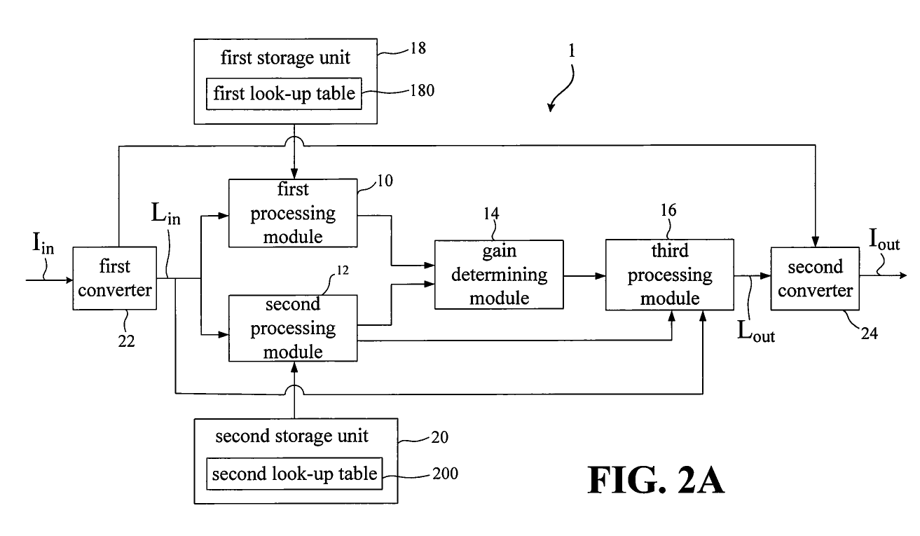

Please refer to FIG. 2A. FIG. 2A illustrates a function block diagram of the image processing apparatus 1 according to an embodiment of the invention. The image processing apparatus 1 of the invention is used for adjusting the lightness of an input image Iᵢₙ to improve the contrast of the input image Iᵢₙ. In general, the input image Iᵢₙ consists of plural pixels and each pixel has a respective input lightness.

As shown in FIG. 2A, the image processing apparatus 1 contains a first converter 22, a second converter 24, a first processing module 10, a second processing module 12, a gain determining module 14, a third processing module 16, a first storage unit 18, and a second storage unit 20. The gain determining module 14 is electrically connected to the first processing module 10 and the second processing module 12. The third processing module 16 is electrically connected to the second processing module 12 and the gain determining module 14. The first converter 22 is electrically connected to the first processing module 10, the second processing module 12, and the third processing module 16. The second converter 24 is electrically connected to the first converter 22 and the third processing module 16. The first storage unit 18 is electrically connected to the first processing module 10, and the second storage unit 20 is electrically connected to the second processing module 12.

In this embodiment, the input image Iᵢₙ conforms to a first color space, e.g. a RGB color space. The converter 22 is used for converting the input image Iᵢₙ from the RGB color space to a second color space with the separation of lightness and colors. By this way, a respective input lightness Lᵢₙ of each pixel can be transmitted to the first processing module 10, the second processing module 12, and the third processing module 16. In practical applications, the second color space can be YCbCr, Yuv, YIQ, CIELab, or Luv.

The first processing module 10 is used for performing a normalization procedure on the plural input lightness of the pixels to obtain a respective normalized lightness of each pixel. In one embodiment, the normalized lightness can be calculated by the following formula:

$${L}_{nor} = \frac{{L}_{in} - {L}_{min}}{{L}_{max} - {L}_{min}} \times 255 ;$$

where Lₙₒᵣ represents the normalized lightness, Lᵢₙ represents the input lightness, Lₘᵢₙ represents a minimum lightness of the image, and Lₘₐₓ represents a maximum lightness of the image.

In general, the pixels of a digital image are recorded in 8 bits. Therefore, the lightness distribution of each pixel is in the range of 0 to 255 gray levels, i.e. 256 gray levels. However, the lightness of a natural image may not be uniformly distributed in the 256 gray levels. For example, the lightness of a darker image may be distributed in the range below the 150 gray level. The advantage of the normalization procedure of the invention is to rearrange the lightness of the whole image and to broaden the lightness distribution for the convenience of a following treatment. Since the 255 gray level is the maximum gray level of an eight-bit image, the distribution of the normalized lightness Lₙₒᵣ after the normalized procedure can be broaden in the range of 0 to 255 gray levels, which is achieved by the above formula.

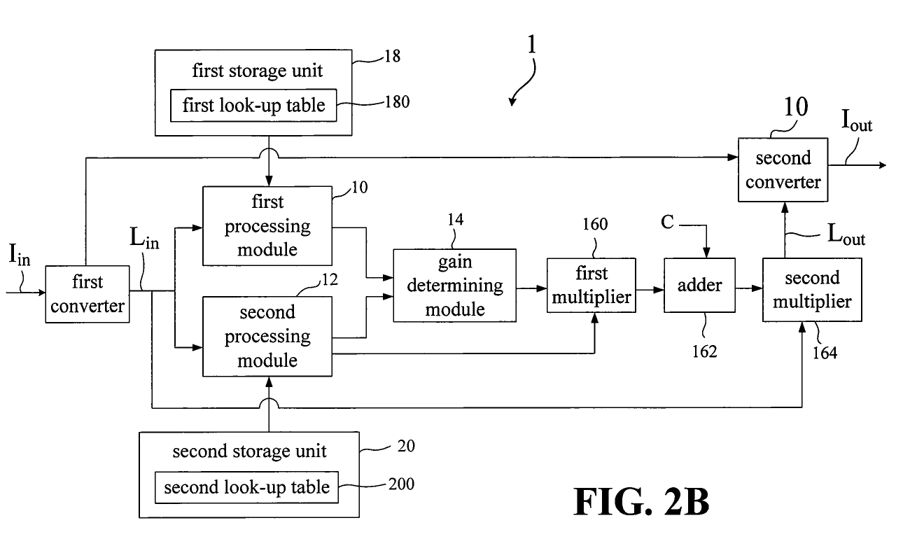

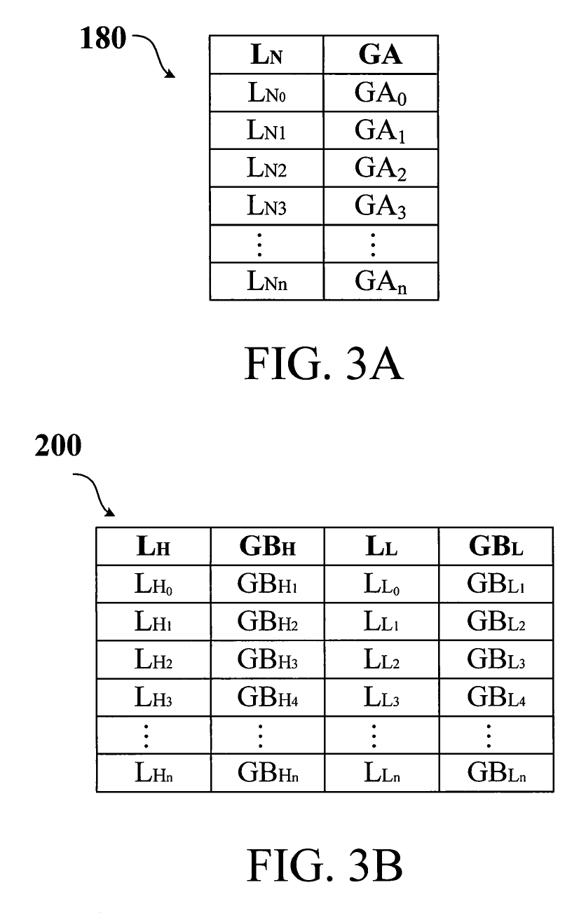

The first processing module 10 is used for determining a first gain corresponding to the normalized lightness Lₙₒᵣ, based on the normalized lightness Lₙₒᵣ and a first gain function. In one embodiment, as shown in FIG. 2A, a first look-up table 180 is stored in the first storage unit 18. And as shown in FIG. 3A, plural normalized lightness L_{N} and plural first gains GA, generated by the first gain function, can be recorded in the first look-up table 180 in advance. Each normalized lightness L_{N} corresponds to one of the first gains GA. When a respective normalized lightness L_{N} of each pixel is transmitted to the first processing module 10, a corresponding first gain GA can be searched out from the first look-up table 180 by the first processing module 10 and can be outputted to the gain determining module 14.

When the plural input lightness Lᵢₙ of the plural pixels are transmitted to the second processing module 12, the second processing module 12 is used for generating a lightness statistics, based on the plural input lightness Lᵢₙ of the plural pixels, and for determining plural threshold lightness based on the lightness statistics. The second processing module 12 is also used for determining plural second gains corresponding to the plural threshold lightness, based on the plural threshold lightness and a second gain function.

In one embodiment, as shown in FIG. 2A, a second look-up table 200 is stored in the second storage unit 20. Plural threshold lightness and plural second gains, generated by the second gain function, can be recorded in the second look-up table 200 in advance. Each threshold lightness corresponds to one of the second gains. Therefore, plural second gains corresponding to the plural threshold lightness can be searched out from the second look-up table 200 by the second processing module 12 and can be outputted to the gain determining module 14.

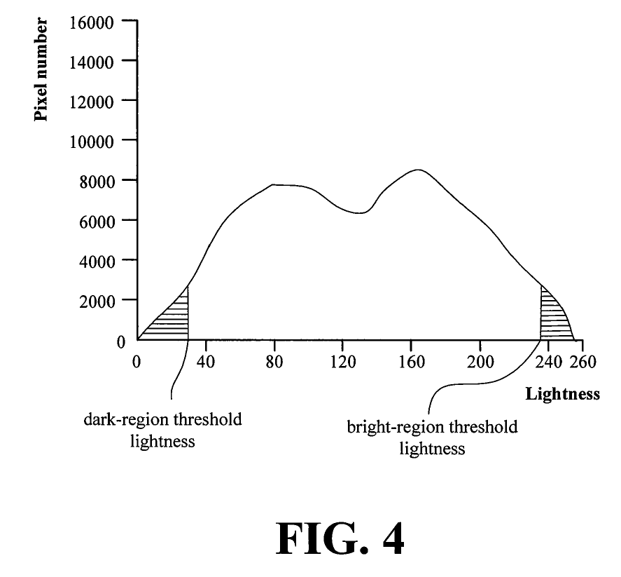

In the following, an example is illustrated to further explain the idea of the invention. In this example, a dark-region threshold lightness and a bright-region threshold lightness can be determined, based on the lightness statistics, by the second processing module 12. As shown in FIG. 4, the lightness statistics can be expressed as a lightness statistical graph. The horizontal axis represents the lightness values of the pixels, and the vertical axis represents the pixel number corresponding to each lightness value.

In one embodiment, the dark-region threshold lightness has a specific gray level in the lightness statistical graph such that the ratio of the calculated area under the curve, from the smallest gray level to the specific gray level (e.g. the left marked area in FIG. 4), to the calculated area under the whole curve in FIG. 4 attains a first threshold value (e.g. 3%). The bright-region threshold lightness has another specific gray level in the lightness statistical graph such that the ratio of the calculated area under the curve, from the biggest gray level to the another specific gray level (e.g. the right marked area in FIG. 4), to the calculated area under the whole curve in FIG. 4 attains a second threshold value (e.g. 3%). It is noted that the first threshold value and the second threshold value are chosen according to practical applications. The dark-region threshold lightness represents the number of the dark pixels in the image; the bigger the dark-region threshold lightness is, the smaller the number of the dark pixels in the image is. On the contrary, the bright-region threshold lightness represents the number of the light pixels in the image; the bigger the bright-region threshold lightness is, the bigger the number of the light pixels in the image is. In addition, as shown in FIG. 3B, plural dark-region threshold lightness L_{L}, plural bright-region threshold lightness L_{H}, plural dark-region lightness gains GB_{L}, and plural bright-region lightness gains GB_{H} are recorded in the second look-up table 200 in advance. Each dark-region threshold lightness L_{L} corresponds to one of the dark-region lightness gains GB_{L}. Each bright-region threshold lightness L_{H} corresponds to one of the plural bright-region lightness gains GB_{H}. Therefore, the dark-region lightness gain GB_{L} and the bright-region lightness gain GB_{H} corresponding to the calculated dark-region threshold lightness L_{L} and the bright-region threshold lightness L_{H}, respectively, can be searched out from the second look-up table 200 by the second processing module 12

The gain determining module 14 can be for determining, based on the first gain GA corresponding to the normalized lightness L_{N} of each pixel, a target second gain corresponding to the normalized lightness L_{N} from the second gains. In practical applications, the gain determining module 14 can be a multiplexer.

In this embodiment, the first gain GA can be in the range of −1 to 1. The aforementioned example can be used herein to explain the function of the gain determining module 14 in detail. When the first gain GA received by the gain determining module 14 is bigger than or equal to 0, the bright-region lightness gain GB_{H} will be outputted to the third processing module 16 by the gain determining module 14; when the first gain GA received by the gain determining module 14 is smaller than 0, the dark-region lightness gain GB_{L} will be outputted by the gain determining module 14.

The third processing module 16 is used for generating an output lightness Lₒᵤₜ corresponding to the input lightness Lᵢₙ of each pixel, based on the input lightness Lᵢₙ, the corresponding first gain GA, and the corresponding target second gain of each pixel. Thereby, the contrast of the input image Iᵢₙ can be adjusted.

Please refer to FIG. 2B. In one embodiment, the third processing module 16 contains a first multiplier 160, an adder 162, and a second multiplier 164. The first multiplier 160 is electrically connected to the second processing module 12 and the gain determining module 14. The adder 162 is electrically connected to the first multiplier 160 and the second multiplier 164. In addition, to understand the idea of the invention well, the input lightness Lᵢₙ of each pixel in the input image Iᵢₙ can be adjusted by the following formula:

G(i)=1+A(i)*B(j);

where A(i) represents the first gain, B(j) represents the target second gain, A(i)*B(j) represents the third gain, and G(i) represents the fourth gain. A(i) is in the range of −1 to 1. B(j) is in the range of 0 to 1. G(i) is in the range of 0 to 2. It is noted that the respective ranges of A(i), B(j), and G(i) are designed according to practical applications, and not limited therein.

G(i)=1+A(i)*B(j);

The first multiplier 160 can be used for multiplying the first gain A(i) by the target second gain (i.e. the dark-region lightness gain or the bright-region lightness gain) B(j) to generate the third gain A(i)*B(j). The bright-region lightness gain can correspond to G(i) bigger than 1, and the dark-region lightness gain can correspond to G(i) smaller than 1. Next, adder 162 can be used for adding the third gain A(i)*B(j) and a default value C together to generate the fourth gain G(i). The default value C can be set as 1, but not limited herein. In principle, the default value can be varied with the first gain A(i) and the target second gain B(j). Afterwards, the second multiplier 164 can be used for multiplying the input lightness Lᵢₙ by the fourth gain G(i) to generate the output lightness Lₒᵤₜ corresponding to the input lightness Lᵢₙ of each pixel.

After the output lightness Lₒᵤₜ are generated by the second multiplier 164, the input image Lᵢₙ can be converted from the second color space (e.g. a Lab color space) to the first color space (e.g. the RGB color space) by the second converter 24, and an output image Iₒᵤₜ can be outputted by the second converter 24.

It can be seen from the aforementioned formula that if the target second gain B(j) is varied, then the fourth gain G(i) is also varied correspondingly. It means that by the image processing apparatus 1 of the invention, the fourth gain G(i) can be adjusted dynamically based on the content of the input image Iᵢₙ to improve the contrast of any kind of image with a specific lightness distribution.

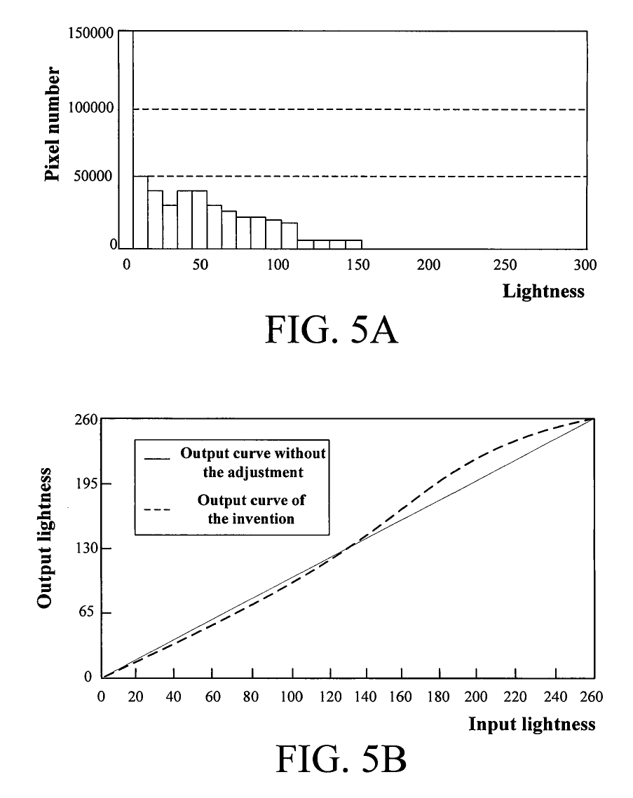

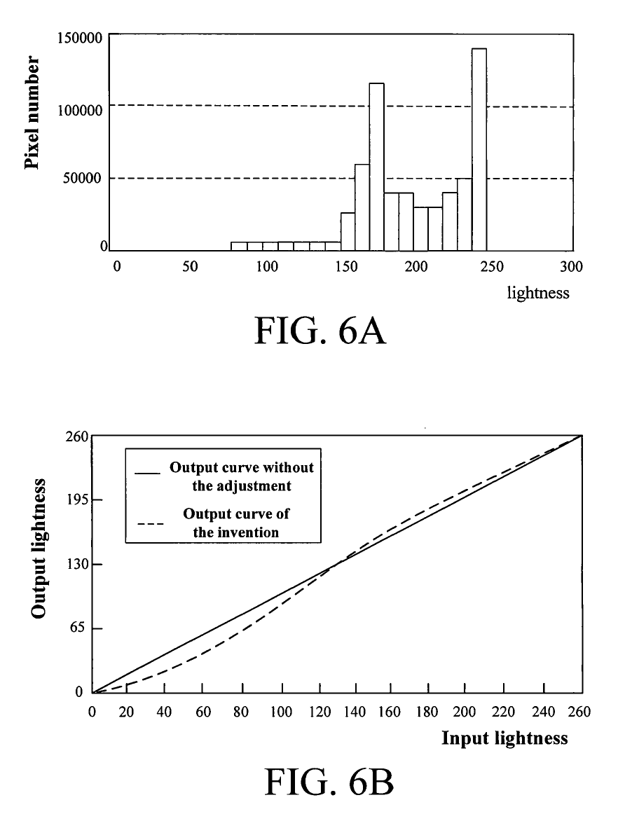

In the following, two examples of different image-adjusting ways are illustrated to highlight the advantage of the image processing apparatus 1 of the invention. Please refer to FIGS. 5A and 6A. FIGS. 5A and 6A illustrate lightness statistical histograms for two images whose contrasts need to be adjusted, respectively. Take FIG. 5A as an example. For increasing the contrast of the image appropriately, it needs to increase the lightness in the high-lightness region (e.g. between 130˜255 gray level) substantially and to decrease the lightness in the low-lightness region (e.g. between 0˜130 gray level) slightly. For adjusting the contrast in this way, the bright-region lightness gain with a value being 0.5 and the dark-region lightness gain with a value being 0.2 can be outputted by the gain determining module 14. Take FIG. 6A as another example. For increasing the contrast of the image appropriately, it needs to increase the lightness in the high-lightness region slightly and to decrease the lightness in the low-lightness region substantially.

Please refer to FIGS. 5B and 6B. FIGS. 5B and 6B illustrate lightness curve simulations for the images, represented by FIGS. 5A and 6A, adjusted by the image processing apparatus 1 of the invention, respectively. As shown in FIG. 5B, after the adjustment, the lightness of the high-lightness region are certainly increased a lot. On the contrary, as shown in FIG. 6B, the lightness of the low-lightness region are certainly decreased substantially. The simulation results of FIGS. 5B and 6B verify that the contrast of an image can be adjusted dynamically and flexibly by the image processing apparatus 1 of the invention.

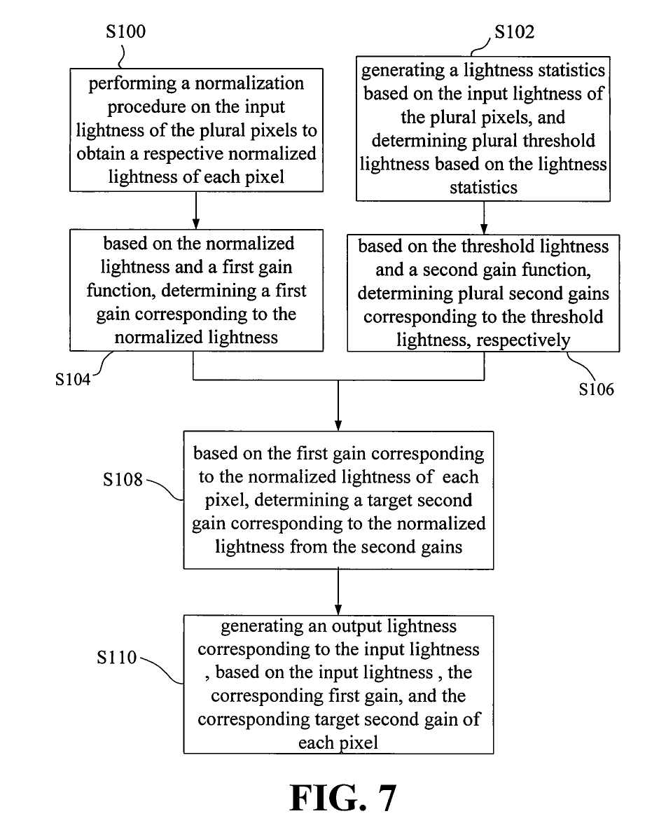

Please refer to FIG. 7. FIG. 7 illustrates a flow chart of an image processing method according to another embodiment of the invention. An input image consists of plural pixels and each pixel has a respective input lightness.

In step S100, a normalization procedure can be executed on the plural input lightness of the plural pixels to obtain a respective normalized lightness of each pixel.

In step S102, a lightness statistics can be generated based on the plural input lightness of the plural pixels, and plural threshold lightness can be determined based on the lightness statistics. The processing procedures of the normalized lightness and the plural threshold lightness are disclosed in the preceding paragraphs, and are not repeated herein.

After step S100, based on the normalized lightness and a first gain function, a first gain corresponding to the normalized lightness can be determined by step S104. In one embodiment, step S104 can be executed by using a look-up table. Plural normalized lightness and plural first gains, generated by the first gain function, are recorded in the look-up table in advance. Each normalized lightness corresponds to one of the first gains.

After step S102, based on the plural threshold lightness and a second gain function, plural second gains corresponding to the plural threshold lightness can be determined by step S106. In one embodiment, step S106 can be executed by using a look-up table. Plural threshold lightness and plural second gains, generated by the second gain function, are recorded in the look-up table in advance. Each threshold lightness corresponds to one of the second gains.

After determining the first gain and the second gains, based on the first gain corresponding to the normalized lightness of each pixel, a target second gain corresponding to the normalized lightness can be determined from the second gains by step S108.

Next, based on the input lightness, the corresponding first gain, and the corresponding target second gain of each pixel, an output lightness corresponding to the input lightness of each pixel can be generated by step S110. Thereby, the contrast of the input image can be adjusted.

In one embodiment, step S110 can be achieved by the following steps. First, a third gain is generated by multiplying the first gain by the target second gain. Next, a fourth gain is generated by adding the third gain and a default value together. Afterwards, an output lightness corresponding to the input lightness of each pixel is generated by multiplying the input lightness by the fourth gain.

Compared to the prior art, the lightness of an input image can be adjusted to improve the contrast of the input image by the image processing apparatus and image processing method of the invention. More particularly, appropriate gains can be chosen dynamically for the high-lightness and low-lightness regions of an input image, respectively. Therefore, even an image with a non-uniform lightness distribution still can be adjusted appropriately to improve the contrast of the image, and to further improve the quality of the image.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An image processing apparatus for adjusting a contrast of an input image, the input image consisting of plural pixels and each pixel having a respective input lightness, the image processing apparatus comprising:
a first processing module for performing a normalization procedure on the plural lightness of the pixels to obtain a respective normalized lightness of each pixel, and determining a first gain corresponding to the normalized lightness based on the normalized lightness and a first gain function;
a second processing module for generating a lightness statistics based on the plural input lightness of the plural pixels, and determining plural threshold lightness based on the lightness statistics, the second processing module also determining, based on the plural threshold lightness and a second gain function, plural second gains corresponding to the plural threshold lightness, respectively;
a gain determining module, electrically connected to the first processing module and the second processing module, for determining, based on the first gain corresponding to the normalized lightness of each pixel, a target second gain, corresponding to the normalized lightness, from the plural second gains; and
a third processing module, electrically connected to the second processing module and the gain determining module, respectively, for generating, based on the input lightness, the corresponding first gain, and the corresponding target second gain of each pixel, an output lightness corresponding to the input lightness of said each pixel to adjust the contrast of the input image.

2. The image processing apparatus of claim 1, wherein the third processing module comprises:
a first multiplier for multiplying the first gain by the target second gain to generate a third gain;
an adder, electrically connected to the first multiplier, for adding the third gain and a default value together to generate a fourth gain; and
a second multiplier, electrically connected to the adder, for multiplying the input lightness by the fourth gain to generate the output lightness corresponding to the input lightness.

3. The image processing apparatus of claim 1, further comprising:
a storage unit, electrically connected to the first processing module and having a look-up table therein, the look-up table recording plural normalized lightness and plural first gains, generated by the first gain function, each normalized lightness corresponding to one of the first gains.

4. The image processing apparatus of claim 1, further comprising:
a storage unit, electrically connected to the second processing module and having a look-up table therein, the look-up table recording plural threshold lightness and plural second gains, generated by the second gain function, each threshold lightness corresponding to one of the second gains.

5. The image processing apparatus of claim 4, wherein the plural threshold lightness comprise a dark-region threshold lightness and a bright-region threshold lightness, the plural second gains comprise plural dark-region lightness gains and plural bright-region lightness gains, the dark-region threshold lightness corresponds to one of the plural dark-region lightness gains, and the bright-region threshold lightness corresponds to one of the plural bright-region lightness gains.

6. The image processing apparatus of claim 1, wherein the normalization procedure determines the normalized lightness by the following formula:
$${L}_{nor} = \frac{{L}_{in} - {L}_{min}}{{L}_{max} - {L}_{min}} * 255 ;$$
wherein Lₙₒᵣ represents the normalized lightness, Lᵢₙ represents the input lightness, Lₘᵢₙ represents a minimum lightness of the image, and Lₘₐₓ represents a maximum lightness of the image.

7. The image processing apparatus of claim 1, further comprising:
a first converter, electrically connected to the first processing module, the second processing module, and the third processing module, the image conforming to a first color space, and the first converter being for converting the image from the first color space to a second color space.

8. The image processing apparatus of claim 7, further comprising:
a second converter, electrically connected to the first converter and the third processing module, for converting the image from the second color space to the first color space.

9. The electronic scratch system of claim 8, wherein the first color space is a RGB color space, and the second color space is a color space selected from the group consisting of YCbCr, Yuv, YIQ, CIELab, and Luv.

10. An image processing method for adjusting a contrast of an input image, the input image consisting of plural pixels and each pixel having a respective input lightness, the image processing method comprising the steps of:
(a) performing a normalization procedure on the plural input lightness of the plural pixels to obtain a respective normalized lightness of said each pixel;
(b) based on the normalized lightness and a first gain function, determining a first gain corresponding to the normalized lightness;
(c) generating a lightness statistics based on the plural input lightness of the plural pixels, and determining plural threshold lightness based on the lightness statistics;
(d) based on the plural threshold lightness and a second gain function, determining plural second gains corresponding to the plural threshold lightness, respectively;
(e) based on the first gain corresponding to the normalized lightness of each pixel, determining a target second gain, corresponding to the normalized lightness, from the second gains; and
(f) based on the input lightness, the corresponding first gain, and the corresponding target second gain of each pixel, generating an output lightness corresponding to the input lightness of said each pixel to adjust the contrast of the input image.

11. The image processing method of claim 10, wherein step (f) is executed by the following steps:
(f1) multiplying the first gain by the target second gain to generate a third gain;
(f2) adding the third gain and a default value together to generate a fourth gain; and
(f3) multiplying the input lightness by the fourth gain to generate the output lightness corresponding to the input lightness.

12. The image processing method of claim 10, wherein step (b) is executed by a look-up table, the look-up table records plural normalized lightness and plural first gains, generated by the first gain function, each normalized lightness corresponds to one of the first gains.

13. The image processing method of claim 10, wherein step (d) is executed by a look-up table, the look-up table records plural threshold lightness and plural second gains, generated by the second gain function, each threshold lightness corresponds to one of the second gains.

14. The image processing method of claim 13, wherein the plural threshold lightness comprise a dark-region threshold lightness and a bright-region threshold lightness, the plural second gains comprise plural dark-region lightness gains and plural bright-region lightness gains, the dark-region threshold lightness corresponds to one of the plural dark-region lightness gains, and the bright-region threshold lightness corresponds to one of the plural bright-region lightness gains.

15. The image processing method of claim 10, wherein the normalization procedure determines the normalized lightness by the following formula:
$${L}_{nor} = \frac{{L}_{in} - {L}_{min}}{{L}_{max} - {L}_{min}} * 255 ;$$
wherein Lₙₒᵣ represents the normalized lightness, Lᵢₙ represents the input lightness, Lₘᵢₙ represents a minimum lightness of the image, and Lₘₐₓ represents a maximum lightness of the image.

16. The image processing method of claim 10, wherein the image conforms to a first color space and the method further comprises the steps of:
before step (a), converting the image from the first color space to a second color space; and
after step (f), converting the image from the second color space to the first 25 color space.

17. The image processing method of claim 16, wherein the first color space is a RGB color space, and the second color space is a color space selected from the group consisting of YCbCr, Yuv, YIQ, CIELab, and Luv.
